(19) United States
(12) Patent Application Publication
(10) Pub. No.: US 2025/0240677 A1
(43) Pub. Date: Jul. 24, 2025

(54) METHODS AND SYSTEM FOR PREDICTION-BASED RADIO RESOURCE MANAGEMENT

(71) Applicant: Samsung Electronics Co., Ltd., Suwon-si (KR)

(72) Inventors: Youn Hyoung Heo, Sunnyvale, CA (US); Abbas Khalili Olam, San Diego, CA (US)

(21) Appl. No.: 19/031,165

(22) Filed: Jan. 17, 2025

Related U.S. Application Data
(60) Provisional application No. 63/623,565, filed on Jan. 22, 2024.

(51) Int. Cl. H04W 36/00

(52) U.S. Cl. CPC H04W 36/0058; H04W 36/00837

(57) ABSTRACT

A system and a method are disclosed for implementing Artificial Intelligence (AI)-based radio resource management (RRM), including RRM prediction, which modifies the application of AI to automatically optimize and control various RRM functions in wireless communication systems, including providing an enhanced AI-based handover procedure. Thus, the system and method may improve the efficiency, range, and overall performance of a wireless communication network through achieving an optimized integration of AI. A method includes obtaining, by a processor, data related to radio resource management (RRM), and the RRM establishes a communication link for user equipment (UE); generating, by an Artificial Intelligence (AI) model, an RRM prediction based on the obtained data related to RRM; transmitting, by the processor, the RRM prediction; and establishing, by the processor, the communication link using the RRM predictions.

### CROSS-REFERENCE TO RELATED APPLICATION

The present application claims priority to and the benefit of U.S. Provisional Application No. 63/623,565, filed on Jan. 22, 2024, entitled “PROCEDURE AND METHODS FOR AI/ML PREDICTION-BASED RADIO RESOURCE MANAGEMENT IN NR,” the entire content of which is incorporated by reference herein.

### FIELD

Aspects of embodiments of the present disclosure relate to wireless communication systems. More particularly, the subject matter disclosed herein relates to improvements to resource management.

### BACKGROUND

Radio resource management (RRM) may be utilized in wireless communication technologies, such as 5G NR (New Radio) technology, to support efficient allocation and/or manage of available radio resources, for example, within the 5G air interface. For example, a function of RRM in 5G NR may include handover management to ensure a seamless transition of user equipment (UEs) between cells and/or beams.

The above information disclosed in this Background section is for enhancement of understanding of the background of the present disclosure, and therefore, it may contain information that does not constitute prior art.

### SUMMARY

The robustness and/or efficiency of Artificial Intelligence (AI) techniques have not been leveraged for RRM, in accordance with some wireless communication technology standards, in a manner that ensures flexibility, mobility, reliability and high-performance connectivity for a wide-range of wireless applications and user devices.

Embodiments of the present disclosure may be directed to systems and methods to implement AI-based RRM, including RRM prediction, which modifies the application of AI to automatically optimize and control various RRM functions in wireless communication systems, including providing an enhanced AI-based handover procedure. Thus, some embodiments of the present disclosure may improve the efficiency, range, and overall performance of a wireless communication network through achieving an optimized integration of AI.

According to some embodiments of the present disclosure, a method includes: obtaining, by a processor, data related to radio resource management (RRM), wherein the RRM establishes a communication link for user equipment (UE);
generating, by an Artificial Intelligence (AI) model, an RRM prediction based on the obtained data related to RRM; transmitting, by the processor, the RRM prediction; and establishing, by the processor, the communication link using the RRM predictions.

According to some embodiments, the RRM prediction includes a predicted value for a measurement parameter of the UE.

According to some embodiments, establishing the communication link comprises performing a handover by a base station.

According to some embodiments, the RRM prediction is based on a measurement configuration for the UE.

According to some embodiments, the method includes: determining a measurement configuration for the UE based on at least one of: a neighbor cell; one or more configuration sets; or a UE selected measurement configuration.

According to some embodiments, the method includes: upon determining the measurement configuration is based on the neighbor cell, receiving data related to the neighbor cell; and generating the RRM prediction based on the data related to the neighbor cell.

According to some embodiments, the method includes: upon determining the measurement configuration is based on the one or more configuration sets, receiving one or more configuration sets for the UE from the base station; selecting at least a configuration set from the one or more configuration sets, wherein the selected configuration set is the measurement configuration for the UE; and generating the RRM prediction based on the selected configuration set.

According to some embodiments, the method includes: upon determining the measurement configuration is based on the UE selected configuration, selecting the measurement parameter from the selected measurement configuration; and generating the RRM prediction based on the selected measurement parameter.

According to some embodiments, transmitting the RRM prediction is based on an event triggering decided by the UE.

According to some embodiments, the method includes determining the transmission of measurement reporting for the RRM prediction is based on at least one of: a source cell threshold; a timer; or a candidate cell.

According to some embodiments, transmitting the RRM prediction includes transmitting a measurement report message to the base station based on the event triggering.

According to some embodiments, the method includes receiving a handover decision based on the RRM prediction.

According to some embodiments, the method includes performing a handover by the base station based on the handover decision.

According to some embodiments, performing the handover includes selecting a target cell for handover.

According to some embodiments, the RRM prediction further includes a predicted radio link failure (RLF).

According to some embodiments, the method includes at least one of: stopping the handover based on the predicted RLF, transmitting the RLF indication, or transmitting the RLF

According to some embodiments, the RRM prediction comprises a predicted value for at least one of: a reference signal received power (RSRP), reference signal received quality (RSRQ), and signal-to-interference-plus-noise ratio (SINR).

According to some embodiments, a device includes: one or more processors that are configured to perform: obtaining data related to radio resource management (RRM), wherein the RRM establishes a communication link for user equipment (UE); generating an RRM prediction based on the obtained data related to RRM using an Artificial Intelligence (AI) model; transmitting the RRM prediction; and establishing the communication link using the RRM predictions.

According to some embodiments, establishing the communication link includes performing handover by a base station based on the RRM prediction.

According to some embodiments, a system includes: a processing circuit; and a memory device storing instructions, which, based on being executed by the processing circuit, cause the processing circuit to perform: obtaining data related to radio resource management (RRM), wherein the RRM establishes a communication link for user equipment (UE); generating an RRM prediction based on the obtained data related to RRM using an Artificial Intelligence (AI) model; transmitting the RRM prediction; and establishing the communication link using the RRM predictions.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 illustrates an example wireless network system implementing Artificial Intelligence (AI)-based radio resource management (RRM), including RRM prediction, according to some embodiments of the present disclosure.

FIG. 2 is a block diagram illustrating an example user equipment (UE) for AI-based RRM implementing an RRM circuit that includes RRM prediction circuitry, according to some embodiments of the present disclosure.

FIG. 3 illustrates an example handover procedure, according to some embodiments of the present disclosure.

FIGS. 4A-4C is a flowchart illustrating a method implementing measurement configuration functions for an AI-based handover procedure, according to some embodiments of present disclosure.

FIG. 5 is a flowchart illustrating a method implementing event triggering functions including predicted event triggering for an AI-based handover procedure, according to some embodiments of the present disclosure.

FIG. 6 is a flowchart illustrating a method implementing operations of the AI-based handover procedure, according to some embodiments of the present disclosure.

FIG. 7 illustrates a system including a UE and a gNB in communications with each other.

FIG. 8 is a block diagram of an electronic device in a network environment, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other examples, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, example, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Radio resource management (RRM) may be a critical component in wireless communication technologies, such as 5G NR, that includes algorithms, functions, and/or procedures for efficiently managing and/or allocating radio resources in the network. RRM may ensure that the radio resources are optimally utilized, thereby providing wireless communication that may achieve high throughput, high reliability, low-latency, and the like, especially in mobile and high-demand environments. Handover management may be a function supported by RRM, where handover may provide a seamless transition of user equipment (UE) between cells and/or beams. RRM procedures may involve using signal measurements and/or thresholds (e.g., reference signal received power (RSRP), refence signal received quality (RSRQ), signal-to-interference-plus-noise ratio (SINR), etc.) to trigger handovers. For example, in 5G NR, a handover mechanism supported by RRM may be a network-controlled layer-3 handover mechanism. During handover, a base station (e.g., gNB) may provide target cell configurations in a handover message (RRC reconfiguration with sync), and the UE may perform handover to the target cell after reception of the handover message (e.g., immediately upon reception). However, failures, limitations, and/or inefficiencies may be experienced in this handover mechanism in some cases, including dense deployment, high frequency, high mobility, high Quality of Service (QOS) applications (e.g. XR, URLLC application), and/or the like.

In the realm of wireless communication technologies, advantages may be realized by leveraging Artificial Intelligence (AI) and/or Machine Learning (ML) techniques to be applied to RRM functions. As AI continues to evolve, its role in RRM may become even more ubiquitous in supporting the next-generation networks with advanced capabilities and higher demands. For example, implementing AI-based RRM may enhance mobility in wireless communication technologies, such as 5G NR.

Handover mechanisms in RRM may rely on performed UE measurements (e.g., Layer 3 measurements) and reporting, such as measured signal strength. Also, in RRM, handover mechanisms may be triggered by one or more events, such as a UE location event (e.g., movement of a UE from one cell (or sub-cell) to another, etc.), a measurement event (e.g., neighboring cell's signal quality is better than a defined threshold, etc.), and/or the like. There may be limitations related to such reliance on UE measurements and/or triggering events, such as increased overhead and/or latency that may be experienced in the handover process. Thus, leveraging AI-based techniques to implement predictive RRM capabilities (e.g., predicted UE measurements and/or triggering events) may realize enhancements to RRM functions that improve the overall quality in wireless communications, including enhanced AI-based handover procedures that may improve handover reliability and/or robustness, reduce service interruptions, and/or the like.

To improve RRM capabilities, embodiments of the present disclosure may provide distinct AI-based RRM techniques, including RRM prediction, that may overcome limitations to AI predictions that are associated with handover procedures in some standard wireless communication technologies.

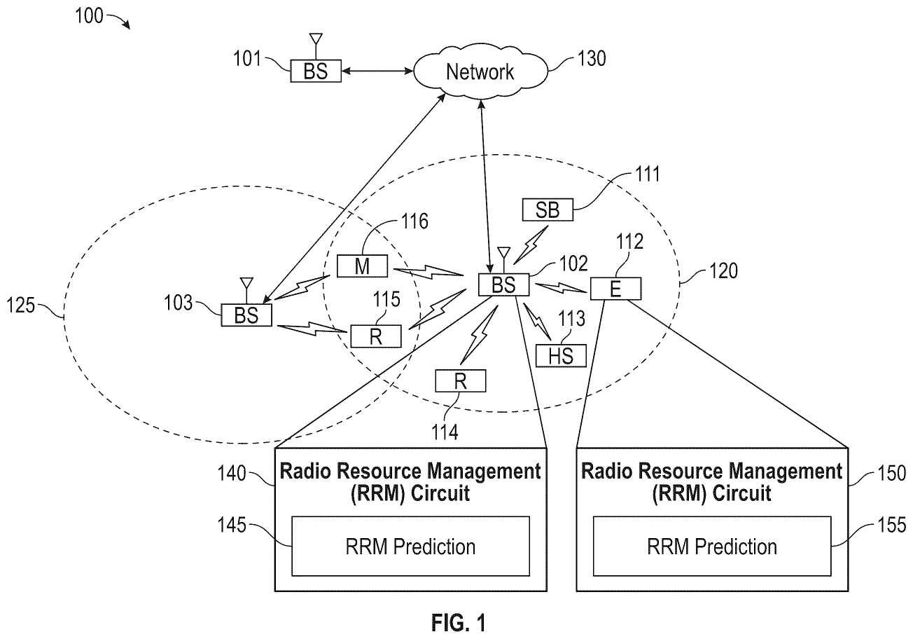

FIG. 1 illustrates an example wireless network system 100 implementing AI-based RRM, including RRM prediction, according to some embodiments of the present disclosure.

As illustrated in FIG. 1, the wireless network system 100 may include multiple base stations (BS), also referred to herein as general Nodes B (gNB), shown as a gNB 101, a gNB 102, and a gNB 103. The gNB 101 may communicate with the gNB 102 and the gNB 103. The gNB 101 may also communicate with at least one network (e.g., an Internet Protocol (IP) network) 130, such as the Internet, a proprietary IP network, or other data network. Instead of gNB, a component may also be referred to herein as an enhanced Node B (eNB). Depending on the network type, other terms can be used instead of gNB or BS, such as “access point” and/or the like. As used herein, “gNB” may refer to a network infrastructure component that provides wireless access to remote terminals. Also, the wireless network 100 may include multiple wireless communication devices that may be associated with an end user, shown as user equipment (UE) 111-116. As used herein, “UE” may refer to remote wireless equipment that wirelessly accesses a gNB. The UEs 111-116 may be implemented as a mobile device (e.g., a mobile telephone, a smartphone, a cellular device, a cell phone, etc.) and/or a stationary device (e.g., a desktop computer, etc.). Depending on the network type, other terms can be used instead of UE, such as “mobile station,” “subscriber station,” “remote terminal,” “wireless terminal,” or “user device.”

The gNB 102 may provide wireless broadband access to a network 130 for multiple UEs within a geographical area covered by the gNB 102, shown as cell 120. As used herein a “cell” may refer to a geographical area covered by a single gNB where a UE can connect to the network. In the example of FIG. 1, the UEs in cell 120 may be situated in disparate remote locations, and may include a UE 111, which can be located in a small business (SB); a UE 112, which can be located in an enterprise (E); a UE 113, which can be located in a WiFi hotspot (HS); a UE 114, which can be located in a first residence (R); a UE 115, which can be located in a second residence (R); and a UE 116, which can be a mobile device (M) like a cell phone, a wireless laptop, a wireless PDA, and/or the like. The gNB 103 may provide wireless broadband access to the network 130 for multiple UEs within a cell 125 of the gNB 103. The UEs in cell 125 may be situated in disparate remote locations, and may include the UE 115 and the UE 116. In some embodiments, one or more of the gNBs 101-103 can communicate with each other and with the UEs 111-116 using wireless technologies in accordance with known standards, including but not limited to: 5G NR; long term evolution (LTE) LTE; long term evolution-advanced (LTE-A); WiMAX; and/or other advanced wireless communication techniques.

Dotted lines in FIG. 1 may represent an approximate extent of the cells 120 and 125, which are shown as approximately circular for the purposes of illustration and explanation. For example, the cells (e.g., coverage areas) associated with gNBs 101, 102, 103, such as the cells 120 and 125, can have other shapes, including irregular shapes, depending upon the configuration of the gNBs 101, 102, 103 and variations in the radio environment associated with natural and man-made obstructions. The gNBs 101, 102, 103 may provide wireless access in accordance with one or more wireless communication protocols including but not limited to: 5G; 5G NR; 3GPP NR; LTE; LTE-A; high speed packet access (HSPA), Wi-Fi 802.11a/b/g/n/ac; and/or other advanced wireless communication techniques.

The gNBs 101-103 may implement a transmit (TX) path that is analogous to transmitting in the downlink (DL) to UEs 111-116, and may implement a receive (RX) path that is analogous to receiving in the uplink from UEs 111-116. In an operational example, the gNB 102 may perform DL transmissions to UEs 111-116 in the coverage area 120. For example, DL transmission from the gNB 102 may involve transmitting data and/or control signals to be received by the UEs 111-116 over a wireless channel, in accordance with one or more wireless communication protocols. DL communication may be utilized for delivering data and/or control signals from the network (e.g., gNB) to the UEs to support several services and/or applications (e.g., browsing Internet content, software updates, streaming services, etc.).

The UEs 111-116 may implement the TX path for transmitting in the uplink (UL) to the gNBs 101-103, and may implement the RX path for receiving in the DL from the gNBs 101-103. In another operational example, one or more of the UEs 111-116 in the coverage area 120 may perform UL transmissions to the gNB 102. As an example, an UL transmission from the UE 112 may involve transmitting data and/or control signals to be received by the gNB 102 over a wireless channel in accordance with one or more wireless communication protocols. The UL communication may be utilized for transmitting user-generated data (e.g., uploads, voice, sensor data, etc.), for example, and maintaining the connections with the gNBs 101-103 through signaling and feedback.

In some embodiments, one or more of the UEs 111-116 may include circuitry, programing, or a combination thereof for implementing the capabilities and/or functions related to AI-based RRM functions including enhanced handover procedures utilized RRM predictions, as disclosed herein. In some embodiments, one or more of the gNBs 101-103 may include circuitry, programing, or a combination thereof for implementing the capabilities and/or functions related to AI-based RRM functions including enhanced handover procedures utilized RRM predictions. For example, FIG. 1 illustrates that gNB 102 may include an RRM circuit 140 including RRM prediction circuitry 145, which enables the gNb 102 to execute the capabilities and/or functions for (network side) AI-based RRM functions including RRM prediction, as disclosed in greater detail herein; and UE 112 may implement or include an RRM circuit 150 including RRM prediction circuitry 155, which enables the UE 112 to execute the capabilities and/or functions for (UE side) AI-based RRM functions including RRM prediction, as disclosed in greater detail herein. In some embodiments, the UE 112 and the gNb 102 are configured to jointly manage the RRM capabilities and/or functions and related RRM configurations, as disclosed herein.

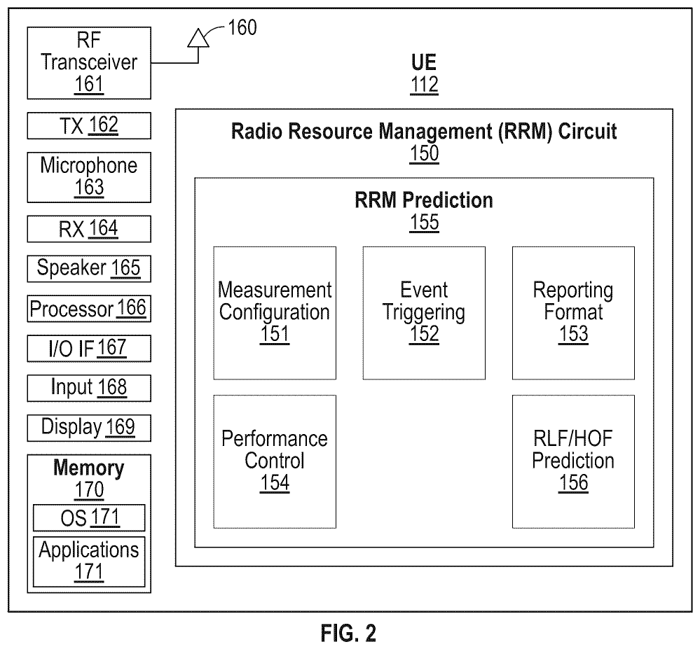

The RRM circuits 140, 150 may implement improved RRM capabilities that include leveraging deep learning techniques, such as artificial intelligence (AI) and machine learning (ML), in such functions. For example, in some embodiments, the RRM circuits 140, 150 may implement enhanced AI-based handover procedures, as disclosed herein. In some embodiments, the RRM prediction circuitry 145, 155 may perform inferred predictions in lieu of and/or in addition to performing operations to obtain actual raw RRM related measurements (e.g., RSRP, etc.), and/or waiting to experience RRM related triggering events (e.g., measurement events, etc.). In some embodiments, the RRM prediction circuitry 145, 155 may perform AI-based prediction of RRM related measurements and/or events in a manner that may mitigate (or reduce) the overhead and/or latency associated with obtaining and reporting actual measurements, and waiting for the occurrence of triggering events. In some embodiments, the RRM circuits 140, 150 may utilize the generated predictions from RRM prediction circuitry 145, 155 to execute AI-based RRM capabilities, such as the enhanced AI-based handover procedures, as disclosed herein. An example configuration and related functions of the RRM circuit 150 and the RRM prediction circuitry 155 are described in greater detail with reference to FIG. 2, for example.

As used herein, “radio resource management” may refer to algorithms, functions, and procedures that may be used to efficiently manage and/or allocate radio spectrum resources in a manner that may aim to optimize network performance (e.g., data throughput, latency, and power consumption, etc.). For example, RRM mechanisms may involve considering factors like channel quality and user demands, and dynamically adjusting radio related parameters (e.g., transmit power, modulation schemes, and time slots assigned to each user, etc.). In some embodiments, the RRM circuits 140, 150 may implement multiple functions related to RRM and management of radio resources for wireless communication, including but not limited to: power control; beam management; dynamic resource scheduling; load balancing handover management; interference management; resource allocation and/or admission control; link adaptation; QoS management; and/or the like, which are improved by utilizing AI techniques.

As used herein, “RRM prediction” may refer to the use of AI/ML related techniques and data analytics to predict and/or optimize the allocation, utilization, and management of radio resources in wireless networks in a manner that may proactively (e.g., rather than reactively) improve resource utilization, reduce delays, and enhance user experience. For example, RRM prediction may involve generating, training, and/or utilizing ML models and inference to predict RRM related measurements (e.g., SINR, RSRP, RSRQ, etc.), reports, and/or trigger events for RRM functions, and may support predictions including, but not limited to: traffic demand prediction; channel quality and/or condition prediction; user mobility prediction; resource allocation optimization; interference prediction and/or management; energy efficiency optimization. In some embodiments, the RRM prediction circuitry 145, 155 may implement one or more aspects of RRM functions, such as executing functions involved in the enhanced AI-based handover procedures, as disclosed herein. In some embodiments, the RRM prediction circuitry 145, 155 may implement multiple functions related to RRM prediction, including but not limited to: measurement configuration; predicted event triggering; report formatting; performance control; and radio link failure (RLF) and/or handover failure (HOF) detection; and/or the like, which are improved by utilizing AI techniques. Thus RRM predictions may include AI-based predictions of one or more parameters, values, functions and/or capabilities related to RRM as deemed suitable and/or appropriate, including, but not limited to: AI-based predicted measurements, including a predicted quality and/or measurement of cell and/or beams; reporting of predicted measurements (e.g., prediction-based reporting, and/or reporting of RRM predictions); AI-based predicted event triggering conditions; AI-based predicted failures, including radio link failure (RLF) and/or handover failure (HOF); and predicted of other parameters that may be pertinent to RRM, as deemed suitable and/or appropriate. For example, a prediction related to a cell/beam quality and/or a prediction of an event triggering condition may be generated at the UE side. Subsequently, the UE can provide measurement reporting (e.g., with and/or without UE measurements) indicating the predicted cell/beam quality as prediction-based RRM reporting.

In some embodiments, the RRM circuits 140, 150 and the RRM prediction circuitry 145, 155 may implement several AI/ML related processes and/or functions as described herein. For example, the beam prediction circuitry 145, 155 may generate, train, and/or utilize AI models to leverage past data and/or real-time data to predict RRM related measurements and/or predict event triggering, and ultimately support prediction-based handover decisions in a manner that may improve the overall performance of the handover procedures (e.g., improving handover reliability and/or robustness, reducing interruptions and/or handover failures, etc.). In some embodiments, the RRM prediction circuitry 145, 155 may implement RRM predictions with respect to handover procedures to ultimately enable selection of optimized and/or suitable target cell, channels, and/or additional resources to support wireless communication. In some embodiments, the RRM circuits 140, 150 and/or the RRM prediction circuitry 145, 155 may implement the enhanced AI-based handover procedures involving functions related to the Radio Resource Control (RRC) approach. Thus, the enhanced AI-based RRM functions described herein, including RRM prediction and enhanced AI-based handover procedures, may be utilized in the wireless network system 100 to realize several advantages associated with optimized handover, such as maintaining efficient and/or reliable communication, achieving high quality signals, and minimizing latency.

In an operational example involving a handover procedure, the UE 112 may need to move from the physical coverage area of cell 120 associated with the gNB 102 to a different coverage area of cell 125 associated with the gNB 103. Accordingly, an AI-based handover procedure, as disclosed herein, may be performed involving UE 112 and gNB 102 to transfer an established wireless connection for an ongoing call and/or data session associated with the UE 112 from one base station to another to prevent call drops and/or data transmission interruptions, for example. In some embodiments, the handover decision in a handover procedure may be based on actual real-time RRM measurements and/or reporting of the UE, which may enable the UE to be connected to the cell that can provide the channel condition deemed optimal and/or suitable for (e.g., overall throughput and latency performance) handover of the connection from a currently utilized cell (e.g., source cell) to a different cell (e.g., target cell).

The handover procedure between the UE 112 and the gNB 102, in accordance with some wireless technology standards (e.g., 5G NR) and RRC approaches, may include UE measurement configuration and reporting configuration. For example, RRM related measurements, such as signal quality of cells, may be utilized in determining a target cell that is optimal and/or suitable for handover. In some embodiments, measurement configuration and reporting configuration during the handover procedure may be set for the UE 112 to perform and/or obtain actual (e.g., real-time) measurements (e.g., RSRP, etc.) of resources (e.g., cells, beams, frequencies, etc.). For example, the handover procedure may utilize reoccurring measurements obtained (e.g., performing real-time measuring) by the UE 112 of the signal quality of source cell and neighboring cells. However, in some embodiments, the RRM prediction circuitry 145, 155 may implement AI-based predictions of RRM related measurements (e.g., replacing actual measurements) in a manner that reduces delays and overhead during handover. In some embodiments, the RRM prediction circuitry 145, 155 may enable prediction of RRM related measurements (e.g., cell and/or beam quality) in lieu of (or in addition to) the UE 112 utilizing time and resources to obtain actual RRM measurements. Thus, the UE 112 may provide measurement reporting to the gNB 112 based on the RRM predictions. In some embodiments, the UE 112 may provide the RRM predictions determined by the AI-based capabilities of the RRM prediction circuitry 145, 155 in a measurement report transmitted to the gNB 102. Subsequently, in some embodiments, the RRM circuit 140 of the gNB 102 may utilize the RRM predictions provided by the measurement report from the UE 112 to determine a handover decision, which may select a target cell for handover.

As described herein, components in a wireless network, such as the gNB 102 and the UE 112, may be enabled to perform enhanced RRM functions to support enhanced AI-based functions, including RRM prediction and enhanced handover procedures. By implementing RRM prediction, wireless technologies, such as 5G NR, may leverage AI-based capabilities to proactively predict RRM measurements, predict event triggering, and other handover related functions, in a manner that may provide reduced disruptions (e.g., efficient handovers), reduced overhead (e.g., reduced measurements), and improved quality of wireless communication (e.g., improved cell selection).

FIG. 2 is a block diagram illustrating an example user equipment (UE) for AI-based RRM implementing an RRM circuit that includes RRM prediction circuitry, according to some embodiments of the present disclosure.

As illustrated in FIG. 2, an example configuration of the UE 112 (e.g., see FIG. 1) may include multiple hardware and/or software components implementing capabilities related to AI-based RRM functions including RRM prediction and enhanced AI-based handover procedures. The UE 112 depicted in FIG. 2 is not intended to be limiting, and the related structure and/or functions of the component may be implemented in a wide variety of configurations, without departing from the scope of this disclosure. In some embodiments, the UE 112 may implement the functions related to AI-based RRM including RRM prediction that are performed on the UE side, as disclosed herein.

Additionally, in some embodiments, a gNB (e.g., gNB 102 shown in FIG. 1) may be configured with similar hardware and/or software components to implement the capabilities related to AI-based RRM including RRM prediction and enhanced AI-based handover procedures, as described herein with reference to FIG. 2. In some embodiments, the gNB may implement the functions related to AI-based RRM management including RRM prediction that are performed on the network side, as disclosed herein.

As shown in FIG. 2, the UE 112 may include an antenna 160, a radio frequency (RF) transceiver 161, TX processing circuitry 162, a microphone 163, and RX processing circuitry 164. The UE 112 may also include a speaker 165, a processor 166, an input/output (I/O) interface (IF) 167, an input device 168, a display 169, and a memory 170. The memory 170 may include an operating system (OS) 171 and one or more applications 172.

The RF transceiver 161 may receive from the antenna 160, an incoming RF signal transmitted by a gNB (e.g., gNB 102 in FIG. 1) of the network 100. The RF transceiver 161 may down-convert the incoming RF signal to generate an intermediate frequency (IF) or baseband signal. The IF or baseband signal can be sent to the RX processing circuitry 164, which may generate a processed baseband signal by filtering, decoding, and/or digitizing the baseband or IF signal. The RX processing circuitry 164 may transmit the processed baseband signal to the speaker 165 (such as for voice data) or to the processor 166 for further processing (such as for web browsing data).

The TX processing circuitry 162 may receive analog or digital voice data from the microphone 163 or other outgoing baseband data (such as web data, e-mail, or interactive video game data) from the processor 166. The TX processing circuitry 162 may encode, multiplexes, and/or digitizes the outgoing baseband data to generate a processed baseband or IF signal. The RF transceiver 161 may receive the outgoing processed baseband or IF signal from the TX processing circuitry 162 and can up-convert the baseband or IF signal to an RF signal that is transmitted via the antenna 160.

The processor 166 may include one or more processors or other processing devices, and may execute the OS 171 stored in the memory 170 in order to control the overall operation of the UE 112. For example, the processor 166 may control the reception of forward channel signals, and the transmission of reverse channel signals by the RF transceiver 161, the RX processing circuitry 164, and the TX processing circuitry 162. In some embodiments, the processor 166 may include at least one microprocessor or microcontroller.

The processor 166 may also be capable of executing other processes and programs resident in the memory 170 and the RRM circuit 150, such as processes for AI-based RRM. The processor 166 may move data into or out of the memory 170 as required by an executing process. In some embodiments, the processor 166 may execute the applications 172 based on the OS 171 or in response to signals received from gNBs or an operator. The processor 166 may also be coupled to the I/O interface 167, which provides the UE 112 with the ability to connect to other devices, such as laptop computers and handheld computers. The I/O interface 167 may provide the communication path between these accessories and the processor 166.

The processor 166 may also be coupled to the input device 168 and the display 169. The operator of the UE 112 may use the input device 168 to enter data into the UE 112. The input device 168 may be a keyboard, touchscreen, mouse, track ball, voice input, or other device capable of acting as a user interface to allow a user in interact with the UE 112. For example, the input device 168 may include voice recognition processing, thereby allowing a user to input a voice command. In another example, the input device 168 may include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme.

The processor 166 may also be coupled to the display 169. The display 169 may be a liquid crystal display, light emitting diode display, or other display capable of rendering text and/or at least limited graphics, such as from web sites.

The memory 170 may be coupled to the processor 166. Part of the memory 170 may include a random-access memory (RAM), and another part of the memory 360 may include a Flash memory or other read-only memory (ROM). In some embodiments, the memory 170 may store data (e.g., measurement configurations, etc.) and/or models (e.g., AI models) associated with functions for AI-based RRM including RRM prediction and enhanced AI-based handover procedures, as disclosed herein. In some embodiments, the memory 170 may store models generated, trained, and/or utilized by the RRM circuit 150 and the RRM prediction circuitry 155.

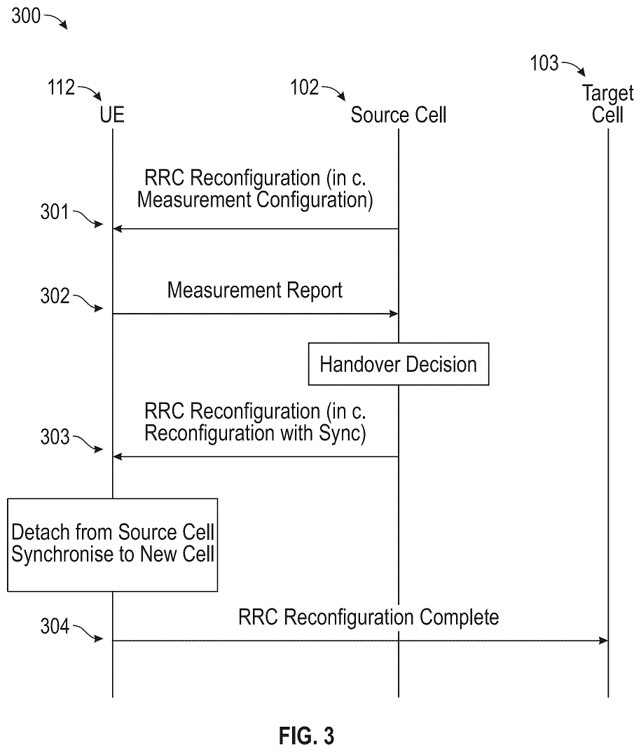

In some embodiments, the RRM circuits 140, 150 may utilize the generated predictions from RRM prediction circuitry 145, 155 to execute AI-based RRM capabilities, such as the enhanced AI-based handover procedures, as disclosed herein. An example of a handover procedure that may be performed by the RRM circuit 150 and may be enhanced by the AI-based predictive capabilities of the RRM prediction circuitry 155 are described in greater detail below with reference to FIG. 3, for example.

The RRM prediction circuitry 155 may include components implementing various aspects of the AI-based beam prediction capabilities of the UE 112, as disclosed herein. In some embodiments, the RRM prediction circuitry 155 may implement AI-based predictions of RRM related measurements (e.g., RSRP, etc.) in lieu of (or in addition to) obtaining actual RRM measurements (e.g., UE 112 performing real-time measurements), in a manner that reduces delays and overhead during handover. The RRM prediction circuitry 155 may receive input data including, but not limited to: UE location; UE trajectory; latest RSRP measurements; and/or the like, and may output predictive results, including but not limited to: predicted cell level RSRP of source cell and/or neighboring cell; TX and/or RX Beam ID(s) and/or the predicted L1-RSRP of the N predicted DL Tx and/Rx beams for source cell and/or neighboring cells; and/or the like.

As illustrated in FIG. 2, the RRM prediction circuitry 155 may also include circuitry, including but not limited to: measurement configuration circuitry 151; event triggering circuitry 152; reporting format circuitry 153; performance control circuitry 154; and RLF/HOF prediction circuitry 156.

The measurement configuration circuitry 151 may enable the UE 112 to perform measurements configuration and reporting in accordance with wireless technology standards (e.g., 5G NR) and RRC approaches. For example, the measurement configuration circuitry 151 may utilize measurement configurations (e.g., measurement objects and reporting configuration including threshold, offset, TimeToTrigger (TTT), etc.) that have been set (e.g., defined) by the gNB. In some embodiments, measurement configuration circuitry 151 may enable the UE 112 to change and/or update the measurement configuration in a manner that is deemed optimal and/or suitable. In some embodiments, one or more measurement configurations may be provided, and the UE 112 may dynamically select at least one measurement configuration based on relevant factors. The one or more measurement configurations may include, but are not limited to: configuring the UE to utilize neighbor cell information broadcasted in System Information Block (SIB) for RRM prediction in connected mode (e.g., instead of measurement configuration in RRC signaling); configuring the UE to select from one or more sets of measurement configurations provided to the UE (e.g., from the gNB); and configuring the UE to determine (e.g., self-select) a measurement configuration (e.g., utilizing an ML model).

The event triggering circuitry 152 may enable the UE 112 to generate RRM predictions related to event triggering and/or related parameters (e.g., proper event, TTT, thresholds, hysteresis, etc.). For example, in some embodiments, the event triggering circuitry 152 may be configured to implement the predicted event trigging conditions and corresponding parameters (e.g., threshold, hysteresis, etc.) that may be utilized during the handover procedure. In some embodiments, the event triggering circuitry 152 may determine that there is a predicted event trigging condition and trigger measurement reporting if there is a prediction that candidate cells may have relatively improved quality at the current time (or in the near future). For example, the UE 112 may be configured to decide when measurement reporting is triggered (event triggering or predicted event triggering condition), and the UE 112 may be configured to decide if measurement reporting is transmitted when the measurement reporting is triggered based on a source cell threshold; a timer; or a candidate cell in a manner that may mitigate overhead associated with frequent measurement reporting.

The event triggering circuitry 152 may receive input data including, but not limited to: UE location; UE trajectory; latest RSRP measurements of the source cell and/or the neighboring cells; and/or the like, and may output predictive results, including but not limited to: proper event; TTT; threshold; hysteresis; and/or the like.

The reporting format circuitry 153 may enable the UE 112 to utilize measurement reporting formats, in accordance with wireless technology standards (e.g., 5G NR) and RRC approaches. For example, the reporting format circuitry 153 may report measurement results of associated measurement object(s) and reporting configuration(s) along with cell (e.g., source cell) measurement results. In some embodiments, the reporting format circuitry 153 may enable the UE 112 to provide one or more “best” candidates (e.g., utilized by the gNB for the handover decision) across frequencies and RATs in the reporting format. For example, the reporting format circuitry 153 may provide the measurement results of one or more candidate frequencies and/or cells that may be determined as suitable and/or optimal (“best”) for the target (or reconfiguration) of the handover procedure along with cell (e.g., source cell) measurement results.

The performance control circuitry 154 may implement performance control functions. In some embodiments, the performance control circuitry 154 may select measurement-based reporting or prediction-based reporting to be utilized for the handover procedure, which may then set the configurations and functions of the gNB 102 and/or UE 112 based on the respective selection. In some embodiments, the performance control circuitry 154 may implement time-based control that enables the UE 112 to perform (e.g., recurringly perform) actual RRM measurements (in addition to RRM prediction) based on a set timing, such as a duty cycle, periodicity, and/or the like.

The RLF/HOF prediction circuitry 156 may implement RLF/HOF prediction. For example, the RLF/HOF prediction circuitry 156 may enable the UE 112 with the capability to indicate the detection and/or a prediction of an RLF/HOF event that may occur at a future time instance to the gNB 102. In some embodiments, the RLF/HOF prediction circuitry 156 may implement a stop of the handover procedure, which may cause a connection back to the source cell, if RLF/HOF occurrence is predicted during the handover procedure. The RLF/HOF prediction circuitry 156 may enable the UE 112 to accelerate an RLF decision to trigger an early RRC connection re-establishment, in some embodiments. The RLF/HOF prediction circuitry 156 may receive input data including, but not limited to: UE location; UE trajectory; latest RSRP measurements of the source cell and/or the neighboring cells; in-sync/out-of-sync information; and/or the like, and may output predictive results, including but not limited to: RLF/HOF occurrence in a future time; and/or the like.

FIG. 3 illustrates an example handover procedure, according to some embodiments of the present disclosure.

FIG. 3 illustrates an example of a handover procedure 300 that may be performed between the UE 112 and the gNB 102 associated with the source cell (e.g., see FIG. 1) that may be enhanced by the AI-based capabilities implemented by the RRM circuits 150, 140 and the RRM prediction circuitry 145, 155, as disclosed herein. Although FIG. 3 illustrates various operations in an example handover procedure according to some embodiments, embodiments according to the present disclosure are not limited thereto. For example, according to some embodiments, the handover procedure may include additional operations or fewer operations, or the order of operations may vary, unless otherwise stated or implied, without departing from the spirit and scope of embodiments according to the present disclosure.

As described herein, AI/ML functions may be leveraged to provide inferred predictions of RRM related measurements (e.g., RSRP, etc.) in lieu of (or in addition to) performing operations to obtain actual raw RRM related measurements and/or waiting to experience RRM related event triggering (e.g., measurement events, etc.). Thus, the AI-based RRM functions may adjust the handover procedure 300 in a manner that may realize various advantages, including mitigating (or reducing) overhead and/or latency, improving reliability (e.g., reduced handover failures, etc.), and/or the like.

Operation 301 may involve the serving gNB 102 communicating an RRC reconfiguration message to the UE 112 that may include measurement configuration parameters. The serving gNB 102 may configure the UE 112 with measurement parameters that may be utilized for performing UE measurement and reporting.

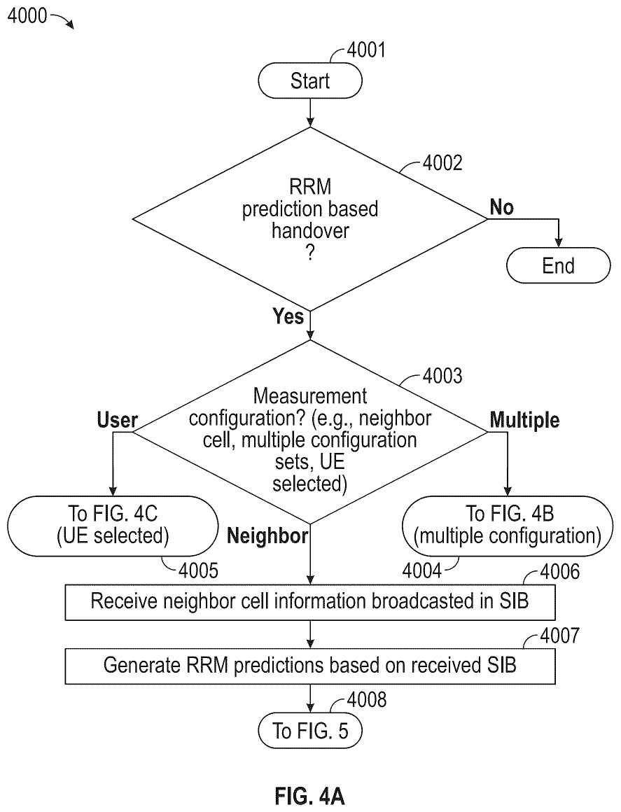

Operation 302 may involve the UE 112 communicating a measurement report message to the serving gNB 102. The UE 112 may perform measurements based on the measurement configuration it received from the serving gNB 102 in previous operation 301. Operation 302 may involve prediction-based reporting, as disclosed in detail herein. In some embodiments, the UE 112 may communicate a measurement report message that indicates generated RRM predictions (e.g., predicted measurements), utilizing the disclosed AI-based RRM functions, in lieu of and/or in addition to obtained RRM measurements (e.g., RSRP, etc.). The UE 112 may be configured to utilize one or more measurement configuration mechanisms for generating AI-based RRM predictions (e.g., predicted measurements) as described in greater detail in reference to FIGS. 4A-4C, for example. The AI-based RRM predictions may then be reported to the serving gNB 102 in operation 302.

Operation 303 may involve the serving gNB 102 generating a handover decision for the UE 112. Based on the measurement report, the serving gNB 102 may determine a handover decision to transfer the UE 112 to a target cell that is associated with the gNB 103 (e.g., see FIG. 1). The serving gNB 102 may identify the target cell for handover of the UE 112 in the handover decision, and may determine the need for resource allocation.

Operation 303 may involve the serving gNB 102 communicating an RRC reconfiguration message to the UE 112. The RRC reconfiguration message may include information related to the handover decision, such as information about the target cell (e.g., gNB 103) and configuration details for the new radio link.

Operation 304 may involve the UE 112 detaching from the source cell (e.g., gNB 102) and synchronizing with the target cell (e.g., gNB 103), and switching its radio connection to the new cell. After a successful synchronization with the target cell, the UE 112 may send an RRC Reconfiguration complete message to the target gNB 103 in operation 304. In some embodiments, one or more operations and/or functions of handover procedure 300 may be adjusted based on the AI-based RRM functions, including RRM prediction, as described herein.

FIGS. 4A-4C is a flowchart illustrating a method implementing measurement configuration functions for an AI-based handover procedure, according to some embodiments of present disclosure.

FIGS. 4A-4C is a flowchart illustrating aspects of operations of a method 4000 for implementing measurement configuration functions of the enhanced AI-based handover procedure, according to some embodiments of the present disclosure. Although FIGS. 4A-4C illustrates various operations in an example handover procedure according to some embodiments, embodiments according to the present disclosure are not limited thereto. For example, according to some embodiments, the handover procedure may include additional operations or fewer operations, or the order of operations may vary, unless otherwise stated or implied, without departing from the spirit and scope of embodiments according to the present disclosure.

Referring to FIG. 4A, the method 4000 may include one or more of the following operations. The method 4000 may start at operation 4001. In some embodiments, the method 4000 may be implemented by the measurement configuration circuitry 151 (e.g., see FIG. 2).

Operation 4002 may involve a determination if the method 4000 is associated with a handover procedure that is based on AI-based RRM prediction. In some embodiments, the UE may determine if RRM related measurements (e.g., cell and/or beam quality) that it executes may be based on performing actual raw RRM measurements (e.g., obtaining actual real-time measurements) and/or based on the AI-based RRM prediction functions to generate RRM predictions (e.g., predicted measurements), as disclosed herein. In some embodiments, the UE may apply a hybrid approach, utilizing both actual RRM measurements and RRM predictions for predicted measurements considering related factors, such as power consumption and measurement accuracy. For example, in a hybrid mode, the UE may dynamically switch between performing actual RRM measurement and/or performing RRM prediction, respectively, for a determined measurement object (e.g., frequency carriers, cells, beams, RATs). Accordingly, the UE may have the capability to perform RRM prediction for some frequency carriers and actual RRM measurements for other frequency carriers, as an example.

If operation 4002 determines that the handover procedure is not based on AI-based RRM prediction (“NO” at 4002), then the method 4000 ends. For example, this may be an indication that the method 4000 is associated with a handover procedure in accordance with wireless technology standards (e.g., 5G NR) and RRC approaches, and may utilize the related measurement configuration (e.g., gNB sets measurement configuration and parameters for the UE) and reporting for the UE.

If operation 4002 determines that the handover procedure is based on AI-based RRM prediction (“YES” at 4002), then the method proceeds to operation 4003.

Operation 4003 may involve a determination of the measurement configuration mechanisms that is being utilized to generate RRM predictions (e.g., predicted measurements). In some embodiments, aspect of the AI-based RRM functions, as disclosed herein, may implement one or more mechanisms that may be employed for implementing measurement configuration in a manner that may be optimized for AI-based functions, including AI-based RRM predictions indicating predicted measurements. The measurement configuration mechanisms may include but are not limited to: neighbor cell based measurement configuration; measurement configuration based on multiple configuration sets; and UE selected measurement configuration. Operation 4003 may determine that the measurement configuration is based on multiple configuration sets, and the method 4000 may continue to operation 4004 described in more detail below with reference to FIG. 4B. Operation 4003 may determine that the measurement configuration is based on the UE selected measurement configuration, and the method 4000 may continue to operation 4005 described in more detail below with reference to FIG. 4C. Operation 4003 may determine that the neighbor cell based measurement configuration is being utilized, and the method continues to operation 4006.

The UE may utilize neighbor cell information broadcasted in System Information Block (SIB) as a measurement configuration mechanism for handover procedures based on RRM prediction (e.g., in a connected mode). In some embodiments, the gNB may configure the handover procedure for AI-based RRM prediction, and/or may indicate to UE to utilize the neighboring cell information in SIBs for the measurement configuration. Accordingly, in operation 4006, the UE may receive neighbor cell information that may be broadcasted in SIBs. In accordance with some wireless technology standards (e.g., 5G NR) one or more SIBs may be broadcasted for cell re-selection and/or measurements (e.g., in RRC idle/inactive mode). Examples of the types of the one or more SIBs that may be broadcasted can include, but are not limited to: cell re-selection information for intra-frequency, inter-frequency and/or inter-RAT cell re-selection as well as intra-frequency cell re-selection information (other than neighboring cell related) (e.g., SIB2); neighboring cell related information relevant for intra-frequency cell re-selection (e.g., SIB3); inter-frequency cell re-selection (e.g., SIB4); and inter-RAT cell re-selection (e.g., SIB5).

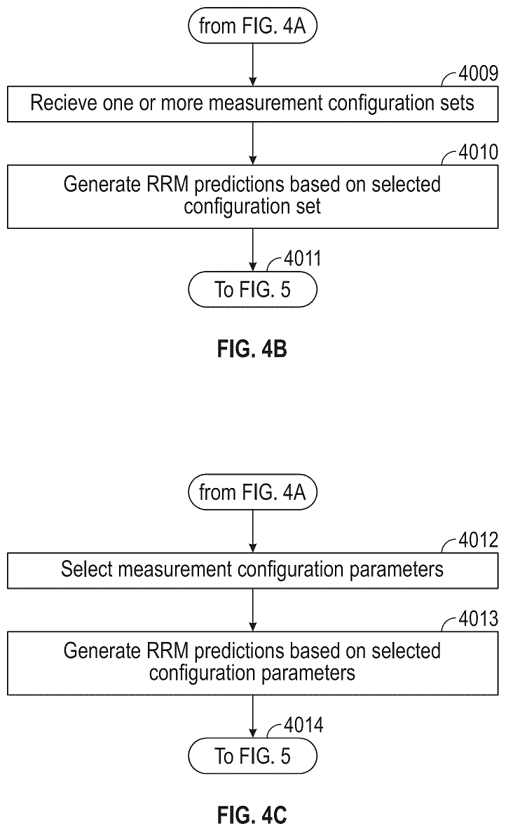

In operation 4007 the RRM predictions (e.g., predicted measurements) may be generated by the UE based on the neighbor cell information received from the SIBs. In cell reselection SIB information, frequency priority information may be included, and the UE may prioritize higher priority frequencies compared to the serving frequency, meaning the UE may perform measurements for higher priority frequencies irrespective of the serving cell quality that is measured. To implement AI-based RRM predictions in operation 4007, in some embodiments, a substantially same priority could be used so that the UE can prioritize prediction based on the broadcasted priorities. In some embodiments, the gNB can configure new and/or additional priorities for connected mode UE to implement AI-based RRM predictions in operation 4007. In addition, the gNB may also provide thresholds if the equal or lower priority frequencies are predicted in the RRM predictions generated in operation 4007. For example, the threshold may be compared to the serving cell channel quality predicated in the RRM predictions (or measured). The method 4000 may then continue to operation 4008 to other operations that may be performed in an enhanced AI-based handover procedure shown in FIG. 5.

Referring now to FIG. 4B, the method 4000 may move to operation 4009 based on the determination, in previous operation 4003 (e.g., see FIG. 4A), that the measurement configuration mechanism is based on multiple configuration sets. Operation 4009 may involve the UE receiving one or more configuration sets from the gNB. Within a same cell, the neighboring cells and measurement related parameters may be different for each UE, because the neighboring cells that each UE may be able to observe may be also different due to different aspects e.g. UE location and/or mobility. If the UE may be able to have an awareness (or predict) such different configurations, it may be possible to enable flexibility in the measurement configurations of the UE. Operation 4009 may involve the gNB providing the one or more configuration sets in the parameters and/or information for measurement configuration. In some embodiments, the one or more configuration sets may be included in a RRC reconfiguration message transmitted to the UE.

TABLE 1

| Set # | Intra-frequency | Inter-frequency |
|---|---|---|
| 1 | PCI list #1 | frequency #1, |
| | | frequency #2, |
| | | frequency #3 |
| 2 | PCI list #2 | frequency #3, |
| | | frequency #4, |
| | | frequency #5 |
| 3 | PCI list #3 | frequency #1, |
| | | frequency #4, |
| | | frequency #7 |

Table 1 illustrates an example of a measurement configuration including multiple configuration sets that may be generated by the gNB. As shown in Table 1, multiple frequencies may be provided in each configuration set. In some embodiments, a measurement configuration may include measurement related configurations related to RRM and RRC approaches (e.g., measurement objects (cell list, frequency, etc.), reference signal configuration including SMTC, Time-to-Trigger, etc.).

Operation 4010 may involve generating RRM predictions (e.g., predicted measurements) based on one or more configuration sets that may be selected by the UE. In some embodiments, the UE may select configuration sets based on the UE location. For example, the UE may be located at a cell edge or cell center. Also, the UE may face different neighboring cells depending on which edge the UE is located in. In this case, the gNB may provide measurement configurations that may be associated with (e.g., labeled to) certain regions. In some embodiments, the measurement configuration sets may utilize GPS based location labeling, and/or serving cell quality-based labeling. In some embodiments, the gNB may include area information in the configuration sets. There may be multiple approaches utilized to define area information for configuration sets, in some embodiments. For example, center and radius information may be set (e.g., defined) for area information that may be included in configuration sets, and/or multiple location points may be set (e.g., defined) to indicate a shape for corresponding area for area information that may be included in configuration sets.

TABLE 2

| Set # | Location information | Intra-frequency | Inter-frequency |
|---|---|---|---|
| 1 | Center_1, distance_1 | PCI list #1 | frequency #1, |
| | | | frequency #2, |
| | | | frequency #3 |
| 2 | Center_2, distance_2 | PCI list #2 | frequency #3, |
| | | | frequency #4, |
| | | | frequency #5 |
| 3 | Center_3, distance_3 | PCI list #3 | frequency #1, |
| | | | frequency #4, |
| | | | frequency #7 |

Table 2 illustrates an example of a measurement configuration including multiple configuration sets that may be generated by the gNB. As shown in Table 1, location information may be provided in each configuration set.

In some embodiments, the UE may select configuration sets based on the UE speed. For RRM measurements that may be inactive and/or idle, the gNB may broadcast different parameters depending on a mobility speed (high, medium, low). Similarly, the gNB may also provide multiple measurement configuration sets including a mobility status, that the UE may select for measurement configurations for the enhanced AI-based handover procedure (e.g., utilizing RRM prediction). A measurement configuration mechanism that provides configuration sets based on mobility may be utilized in scenarios where larger coverage of cells are used for high-speed cases, and such larger cells may be located in a certain carrier (e.g., based on operators' deployment plan).

TABLE 3

| Set # | Mobility status | Intra-frequency | Inter-frequency |
|---|---|---|---|
| 1 | low | PCI list #1 | frequency #1, |
| | | | frequency #2, |
| | | | frequency #3 |
| 2 | medium | PCI list #2 | frequency #3, |
| | | | frequency #4, |
| | | | frequency #5 |
| 3 | high | PCI list #3 | frequency #1, |
| | | | frequency #4, |
| | | | frequency #7 |

Table 3 illustrates an example of a measurement configuration including multiple configuration sets that may be generated by the gNB. As shown in Table 3, mobility status information may be provided in each configuration set. In some embodiments, the UE may select the configuration set utilized for its measurement configuration utilizing AI/ML capabilities and/or predictions. For example, the UE may apply an AI model trained to predict configuration sets (e.g., provided in the received RRC reconfiguration message) that may be suitable and/or optimal for RRM prediction aspects of the enhanced AI-based handover procedure.

The method 4000 may then continue to operation 4011 to other operations that may be performed in an enhanced AI-based handover procedure shown in FIG. 5.

Referring now to FIG. 4C, the method 4000 may move to operation 4012 based on the determination, in previous operation 4003 (e.g., see FIG. 4A), that the measurement configuration mechanism is based on the UE selected measurement configuration. Operation 4012 may involve the UE selecting (e.g., self-selecting) configuration parameters for its measurement configuration as an independent mechanism (e.g., without being configured by the gNB). In some embodiments, the UE may be able to apply AI-based capabilities and/or AI models to derive values for measurement related parameters (e.g. Time-to-Trigger, thresholds, hysteresis, event type, etc.) that may suitable and/or optimal. In this case, that gNB may not need to provide measurement configurations to the UE.

Operation 4013 may involve the UE then utilizing its determined (e.g., self-selected) measurement configuration to generate RRM predictions (e.g., predicted measurements). The UE may provide the parameters that it derived for its selected measurement configuration to gNB either along with prediction results or separately in UE assistance information (UAI) message (e.g., when gNB requests).

The method 4000 may then continue to operation 4014 to other operations that may be performed in an enhanced AI-based handover procedure shown in FIG. 5.

FIG. 5 is a flowchart illustrating a method implementing event triggering functions, including predicted event triggering, for an AI-based handover procedure, according to some embodiments of the present disclosure.

FIG. 5 is a flowchart illustrating operations of a method 5000 for implementing event triggering functions of the enhanced AI-based handover procedure, according to some embodiments of the present disclosure. In some embodiments, the method 5000 may be implemented by the event triggering circuitry 152 (e.g., see FIG. 2). Although FIG. 5 illustrates various operations in an example handover procedure according to some embodiments, embodiments according to the present disclosure are not limited thereto. For example, according to some embodiments, the handover operation may include additional operations or fewer operations, or the order of operations may vary, unless otherwise stated or implied, without departing from the spirit and scope of embodiments according to the present disclosure.

The method 5000 may start at operation 5001. In some embodiments, measurement reporting for the enhanced AI-based handover procedure (including RRM prediction) may be based on event triggering conditions that are applied to cause reporting of the RRM predictions generated in FIGS. 4A-4C, for example. The event triggering implemented by method 5000 may be enhanced by RRM predictions. For example, the UE may trigger measurement reporting (e.g., including prediction-based reporting) utilizing an AI-based prediction of an event trigger, including if there are candidate cell(s) which may be predicted to have a better quality in the future (e.g., depending on predictions generated utilizing the AI-based capabilities, as disclosed herein).

Operation 5002 may involve generating RRM predictions for predicted measurements, for instance based on measurement configuration functions for the enhanced AI-based handover procedure, as performed in the operations of method 4000 in FIGS. 4A-4C. For example, an event triggering (e.g., predicted event triggering condition) may be utilized to trigger prediction-based reporting (e.g., reporting the RRM predictions on cell/beam quality).

In some embodiments, the method 5000 for implementing event triggering may be modified in a manner that supports the functionality of prediction-based RRM reporting, enabling various event triggering mechanisms. Operations 5003-5005 may involve determining the event triggering mechanism that is being utilized to trigger sending a measurement report, including the determined RRM predictions (e.g., predicted measurements), to the gNB. In some embodiments, aspect of the AI-based RRM functions, as disclosed herein, may implement one or more mechanisms that may be employed for implementing event triggering, including predicted event triggering. The measurement configuration mechanisms may include but are not limited to: source cell threshold-based event triggering; prohibit timer-based event triggering; and candidate cell based event triggering.

Operation 5003 may involve determining if the event triggering is based on a source cell threshold. Operation 5003 may involve determining if the source cell channel quality is better than a threshold. In some embodiments, the threshold for the source cell channel quality may be a value that is set (e.g., defined) by the gNB. If the serving cell channel quality is better than the threshold (e.g., “Yes” at 5003), then the RRM prediction may not be reported, and the method 5000 may return to operation 5002. In some embodiments, prediction reporting may not be triggered if the source cell channel quality is better than the threshold, except in a case where the UE finds a candidate target cell in a higher priority frequency (e.g., assuming that gNB configures priority of frequency). Operation 5003 may determine that the serving cell channel quality is not better than the threshold (e.g., “NO” at 5003), which triggers reporting of the RRM, and thus, the method 5000 may proceed to operation 5006 to transmit the measurement report to the gNB.

Operation 5004 may involve determining if the event triggering is based on a prohibit timer. In some embodiments, the prohibit timer is a set (e.g., defined) time period where the UE does not perform reporting. Thus, if it determined in operation 5004 that the event triggering is based on a prohibit timer, then operation 5004 may involve determining whether the current time instance is within the time period of the prohibit timer. Operation 5004 may determine that the current time instance is within the time period set by the prohibit timer (“YES” at 5004), then the RRM prediction may not be reported, and the method 5000 may return to operation 5002. Operation 5004 may determine that the current time example is not within the time period set by the prohibit timer (“NO” in FIG. 5), which may indicate the prohibit timer has expired, and may trigger reporting of the RRM predictions. Thereafter, the method 5000 may proceed to operation 5006, and the measurement report may be transmitted to the gNB. In some embodiments, the prohibit timer-based event triggering mechanism may set (e.g., define) a single timer that may be utilized to control measurement reporting. Alternatively, multiple timers (same or different timer values) may be set for the prohibit timer-based event triggering mechanism, where a different timer may be applied for different prediction cases (e.g. intra-frequency, inter-frequency or inter-RAT cases)

In some embodiments, measurement reporting is utilized to ultimately identify a candidate target cell for handover. Thus, operation 5005 may involve determining a predicted event triggering condition when the UE triggering measurement reporting is performed when there are candidate cell(s) which may be predicted to have better quality (e.g., in the near future depending on prediction algorithm). For example, if it is determined in operation 5005 that the event triggering is based on predicted candidate cells, then operation 5005 may involve determining whether the candidate cell(s) may have better quality than the source cell. Operation 5005 may determine that none of the candidate cell(s) have better quality than the source cell (“NO” at 5005), then the RRM prediction (e.g., predicted measurements) may not be reported, and the method 5000 may return to operation 5002. Operation 5005 may determine that one or more candidate cells as the gNB configures may have better quality than the source cell (“YES” at 5005), which may implement a prediction-based triggering (e.g., predicted event triggering condition) of prediction-based reporting (e.g., reporting RRM predictions for predicted measurements). Thereafter, the method 5000 may proceed to operation 5006, and the measurement report may be transmitted to the gNB.

For example, the UE may predict (e.g., RRM prediction) the current beam (e.g. spatial prediction of beam) of candidate cells, and the measurement reporting may be based on the condition of the candidate cells. The candidate cells may be intra-frequency and/or inter-frequency or inter-RAT neighboring cells. In some embodiments, the number of neighboring cells and/or the number of frequencies that may be included in the measurement reporting message may be decided by the UE and/or configured by gNB. In some embodiments, the neighboring cells that may be included (e.g., ordering of cells) may be set if there are a greater number of cells that the UE can predict. For example, the number of candidates reported may be decided by gNB (e.g. by explicitly indicating the high priority of cells), and/or the number candidates reported may be based on the measurement result (i.e., better channel quality).

The method 5000 may implement event triggering, including predicted event triggering, for the enhanced AI-based handover procedure that may realize several advantages, including reduced signaling overhead (e.g., reduced and/or limited frequency of measurement reporting) and improved reliability (e.g., reduced occurrence of handover occurring before the target cell is ready).

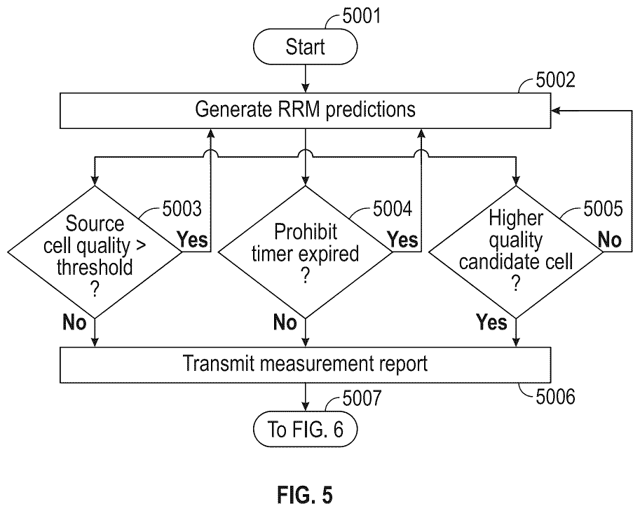

The method 5000 may then continue to operation 5007 to other operations that may be performed in an enhanced AI-based handover procedure shown in FIG. 6.

FIG. 6 is a flowchart illustrating a method implementing operations of the AI-based handover procedure, according to some embodiments of the present disclosure.

Although FIG. 6 illustrates various operations in an example handover procedure according to some embodiments, embodiments according to the present disclosure are not limited thereto. For example, according to some embodiments, the handover operation may include additional operations or fewer operations, or the order of operations may vary, unless otherwise stated or implied, without departing from the spirit and scope of embodiments according to the present disclosure.

The method 6000 may start at operation 6001. In some embodiments, operation 6002 may involve generating RRM predictions (e.g., predicted measurements) based on measurement configurations as performed by the operations described above with reference to FIGS. 4A-4C in accordance with the disclosed measurement configuration functions. In some embodiments, operation 6003 may involve transmitting a measurement reporting message based on an RRM prediction (e.g., predicted event triggering event condition), as performed by the operations described above with reference to FIG. 5 in accordance with the disclosed predicted event triggering functions.

Operation 6004 may involve receiving an RRC reconfiguration message from the gNB that may include a handover decision. The gNB may generate a “predicted” handover decision for the UE based on the RRM predictions (e.g., predicted measurements that are received in the transmitted measurement report). For example, the gNB may determine a handover decision to transfer the UE to a new target cell based on the prediction that the target cell may have a higher signal quality than the source cell. The RRC reconfiguration message received by the UE in operation 6004 may include information related to the handover decision, such as information about the target cell and configuration details for handover of the new radio link.

Operation 6005 may involve the executing of the RRC reconfiguration that is indicted in the RRC reconfiguration in previous operation 6004. In operation 6005, the UE may synchronize with the target cell for handover and switch its radio connection to the new cell. The method 6000 may end at operation 6006, ending the AI-based handover procedure.

In some embodiments, one or more operations and/or functions of method 6000 implementing the handover procedure may be adjusted based on the AI-based RRM functions, including RRM prediction, as described herein.

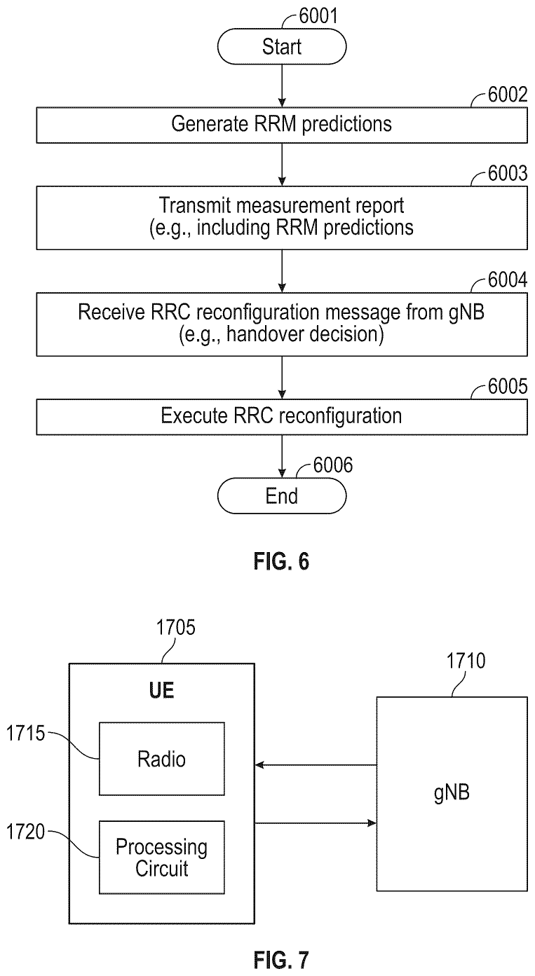

FIG. 7 illustrates a system including a UE and a gNB in communications with each other.

FIG. 7 shows a system including a UE 1705 and a gNB 1710, in communication with each other. The UE 1705 may include a radio 1715 and a processing circuit (or a means for processing) 1720, which may perform various methods disclosed herein, e.g., the functions and methods illustrated in FIG. 1. For example, the processing circuit 1720 may receive, via the radio 1715, transmissions from the network node (gNB) 1710, and the processing circuit 1720 may transmit, via the radio 1715, signals to the gNB 1710.

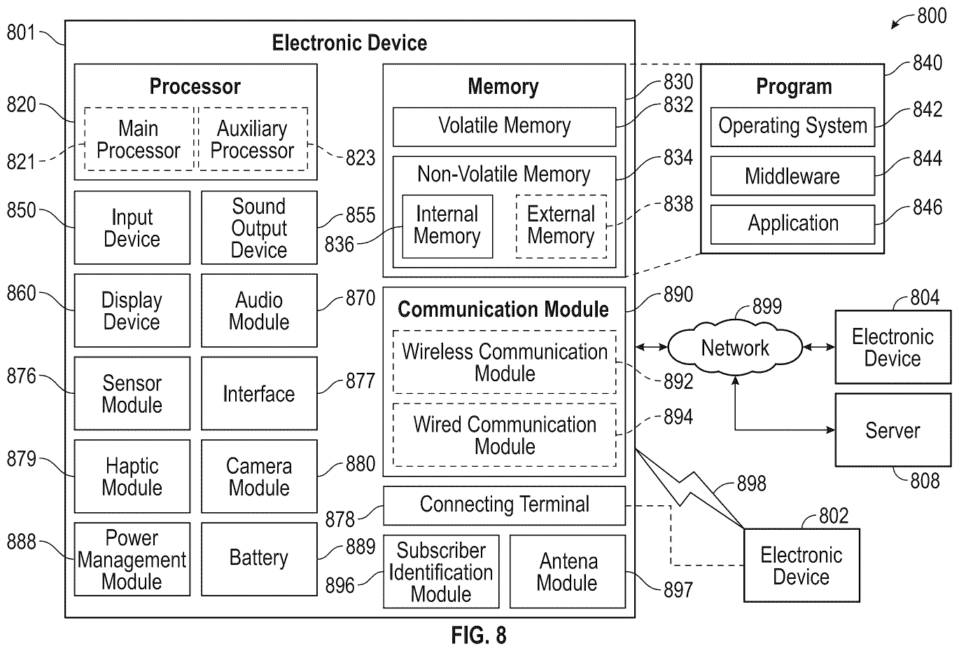

FIG. 8 is a block diagram of an electronic device in a network environment, according to some embodiments of the present disclosure.

Referring to FIG. 8, an electronic device 801 in a network environment 800 may communicate with an electronic device 802 via a first network 898 (e.g., a short-range wireless communication network), or with an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, and/or an antenna module 897. In one embodiment, at least one of the components (e.g., the display device 860 or the camera module 880) may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled to the processor 820, and may perform various data processing or computations.

As at least part of the data processing or computations, the processor 820 may load a command or data received from another component (e.g., the sensor module 876 or the communication module 890) in volatile memory 832, may process the command or the data stored in the volatile memory 832, and may store resulting data in non-volatile memory 834. The processor 820 may include a main processor 821 (e.g., a central processing unit or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or to execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890), as opposed to the main processor 821 while the main processor 821 is in an inactive (e.g., sleep) state, or together with the main processor 821 while the main processor 1821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 860 may visually provide information to the outside (e.g., to a user) of the electronic device 801. The display device 860 may include, for example, a display, a hologram device, or a projector, and may include control circuitry to control a corresponding one of the display, hologram device, and projector. The display device 860 may include touch circuitry adapted to detect a touch, or may include sensor circuitry (e.g., a pressure sensor) adapted to measure the intensity of force incurred by the touch.

The audio module 870 may convert a sound into an electrical signal and vice versa. The audio module 870 may obtain the sound via the input device 850 or may output the sound via the sound output device 1855 or a headphone of an external electronic device 802 directly (e.g., wired) or wirelessly coupled to the electronic device 801.

The sensor module 876 may detect an operational state (e.g., power or temperature) of the electronic device 801, or an environmental state (e.g., a state of a user) external to the electronic device 801. The sensor module 876 may then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 877 may support one or more specified protocols to be used for the electronic device 801 to be coupled to the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected to the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus, which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power that is supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell that is not rechargeable, a secondary cell that is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808), and may support performing communication via the established communication channel. The communication module 890 may include one or more communication processors that are operable independently from the processor 820 (e.g., the AP), and may support a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)), or via the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas. The communication module 890 (e.g., the wireless communication module 1892) may select at least one of the one or more antennas appropriate for a communication scheme used in the communication network, such as the first network 1898 or the second network 899. The signal or the power may then be transmitted or received between the communication module 890 and the external electronic device via the selected at least one antenna.

Commands or data may be transmitted or received between the electronic device 801 and the external electronic device 804 via the server 808 coupled to the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, cloud computing, distributed computing, or client-server computing technology may be used, for example.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, aspects of some embodiments of the subject matter have been described herein. Other embodiments are within the scope of the following claims, and their equivalents. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, and their equivalents.

What is claimed is:

1. A method comprising:
obtaining, by a processor, data related to radio resource management (RRM), wherein the RRM establishes a communication link for user equipment (UE);
generating, by an Artificial Intelligence (AI) model, an RRM prediction based on the obtained data related to RRM;
transmitting, by the processor, the RRM prediction; and
establishing, by the processor, the communication link using the RRM predictions.

2. The method of claim 1, wherein the RRM prediction comprises a predicted value for a measurement parameter of the UE.

3. The method of claim 2, wherein establishing the communication link comprises performing a handover by a base station.

4. The method of claim 3, wherein the RRM prediction is based on a measurement configuration for the UE.

5. The method of claim 4, further comprising:
determining a measurement configuration for the UE based on at least one of: a neighbor cell; one or more configuration sets; or a UE selected measurement configuration.

6. The method of claim 5, further comprising:
upon determining the measurement configuration is based on the neighbor cell, receiving data related to the neighbor cell; and
generating the RRM prediction based on the data related to the neighbor cell.

7. The method of claim 5, further comprising:
upon determining the measurement configuration is based on the one or more configuration sets, receiving one or more configuration sets for the UE from the base station;
selecting at least a configuration set from the one or more configuration sets, wherein the selected configuration set is the measurement configuration for the UE; and
generating the RRM prediction based on the selected configuration set.

8. The method of claim 4, further comprising:
upon determining the measurement configuration is based on the UE selected configuration, selecting the measurement parameter from the selected measurement configuration; and
generating the RRM prediction based on the selected measurement parameter.

9. The method of claim 5, wherein transmitting the RRM prediction is based on an event triggering decided by the UE.

10. The method of claim 9, further comprising determining the transmission of measurement reporting for the RRM prediction is based on at least one of: a source cell threshold; a timer; or a candidate cell.

11. The method of claim 9, wherein transmitting the RRM prediction comprises transmitting a measurement report message to the base station based on the event triggering.

12. The method of claim 11, further comprising receiving a handover decision based on the RRM prediction.

13. The method of claim 12, further comprising performing a handover by the base station based on the handover decision.

14. The method of claim 13, wherein performing the handover comprises selecting a target cell for handover.

15. The method of claim 1, wherein the RRM prediction further comprises a predicted radio link failure (RLF).

16. The method of claim 15, further comprising at least one of: stopping the handover based on the predicted RLF, transmitting the RLF indication, or transmitting the RLF.

17. The method of claim 2, wherein the RRM prediction comprises a predicted value for at least one of: a reference signal received power (RSRP), reference signal received quality (RSRQ), and signal-to-interference-plus-noise ratio (SINR).

18. A device comprising:
one or more processors that are configured to perform:
obtaining data related to radio resource management (RRM), wherein the RRM establishes a communication link for user equipment (UE);
generating an RRM prediction based on the obtained data related to RRM using an Artificial Intelligence (AI) model;
transmitting the RRM prediction; and
establishing the communication link using the RRM predictions.

19. The device of claim 18, wherein establishing the communication link comprises performing handover by a base station based on the RRM prediction.

20. A system comprising:
a processing circuit; and
a memory device storing instructions, which, based on being executed by the processing circuit, cause the processing circuit to perform:
obtaining data related to radio resource management (RRM), wherein the RRM establishes a communication link for user equipment (UE);
generating an RRM prediction based on the obtained data related to RRM using an Artificial Intelligence (AI) model;
transmitting the RRM prediction; and
establishing the communication link using the RRM predictions.
